(19) United States
(12) Patent Application Publication
(10) Pub. No.: US 2015/0254073 A1
(43) Pub. Date: Sep. 10, 2015

(54) System and Method for Managing Versions of Program Assets

(71) Applicant: SHERPA TECHNOLOGIES INC., Boisbriand (CA)

(72) Inventor: Éric-Pierre Ménard, Boisbriand (CA)

(21) Appl. No.: 14/418,829

(22) PCT Filed: Aug. 1, 2013
(86) PCT No.: PCT/CA2013/050599

§ 371 Date: Jan. 30, 2015

Related U.S. Application Data
(60) Provisional application No. 61/678,395, filed on Aug. 1, 2012.

(51) Int. Cl. G06F 9/44; G06F 17/30; G06F 3/0484

(52) U.S. Cl. CPC G06F 8/71; G06F 3/04842; G06F 17/30477

(57) ABSTRACT

A method and system for managing versions of program assets of a library is disclosed, to be used for example with IBM Infosphere Datastage™. Each program asset has source code which is protected. A selection of one or more program asset to be exported into the utility application is selected. Instructions for building the source code of each pro gram asset is extracted from the library and into a digest. A database stores each digest as a new instance of the digest in a data storage and associates thereto a new version identifier representing a new version of the corresponding program asset. A checked-in status is further associated to each new instance of digest, to indicate that the digest is stored in the utility application.

### FIELD OF THE INVENTION

The present invention relates to a version control system and method. More particularly, the present invention relates to a version control method for controlling versions of protected source code and to a system for performing the same.

### BACKGROUND OF THE INVENTION

Source control, also known as revision control or version control, is an important practice of software development. It allows for the management of changes to documents and programs, by registering the source code at each change, and also provides developers a variety of functionalities, including the reservation of files by means of a check-in, check-out procedure and can also handle conflicts between simultaneous changes of the same program (“merging”).

Release management, in software development, automates and/or allows better control of the deployment and maintenance of all the different versions of programs through the evolutionary phases, such as development, testing and production environments

Extract-Transform-Load (ETL) is a field of information technology that handles the transportation and integration of data. ETL programs make possible the transmission of data between various computer systems such as sending billing information to an application responsible of invoicing, from a product sold using a customer relationship management application (CRM). ETL programs are also heavily used in loading data warehouses and when replacing outdated computer systems by new technology that requires preserving relevant data accumulated throughout the years in the older system.

IBM Infosphere Datastage™ (also referred to herein as “Datastage™”) is a component of the IBM Information Server™ suite of applications, and is recognized worldwide as a leader in the field of ETL. The latter is widely distributed throughout North America, Europe and Asia.

Version control and release management practices are widely spread in the IT community. There are to date more than two dozen unique solutions, with as many offered under free license as paid proprietary licenses. IBM Rational ClearCase™, CVS™, Subversion™, Microsoft Team Foundation Server™ and Git™ are among the best known.

Despite the multitude of applications available, no software known to the Applicant is adapted to integrate programs such as those created by DataStage™, due to the complexity and uniqueness of its architecture. While modern programming is mostly text-based and usually consisting of several independent text files, each of which can be accessed and saved individually (Java™, PHP, C/C++, etc.), DataStage™ on the other hand is a graphical tool (see FIG. 1). Template modules representing functions are dragged to the design screen from a palette and are linked together to be finally customized for specific needs. Behind the scenes, the actual code is separated into design files, executable binaries and metadata stored in a database. All those artifacts compose a single program. Those components are write-protected by Datastage™ so as to prevent direct access. In such an environment, modifications to programs must be done via an application layer of Datastage™.

It is however possible to manually extract a summary of each program composition into either an XML format file or a file format proprietary to DataStage™, called “DSX”. This summary can then be used by Datastage™ to recreate a program in its original form. This is the most common practice today for managing Datastage™ programs. Users export each component either individually or as a bundle into a processing summary file. This file is then uploaded into a source management program. When an archived version of a program is required in a Datastage™ project, the appropriate file is extracted from the source management program and then manually imported into the project. This is a tedious task which, since it requires manual manipulations, increases the risk of errors.

Shown in FIGS. 2A and 2B are two flow charts illustrating the manual versioning steps required, namely FIG. 2A exemplifies the exporting of a program from a Datastage™ project, and FIG. 2B exemplifies the importing of a program into a target Datastage™ project (i.e. recreating the program in Datastage™). FIG. 3 illustrates the data flow between the Datastage™ environments using a conventional source control application.

DataStage™ does provide some level of automation for extracting and importing of programs. DataStage™ provides an implementation of certain key controls by various DOS or UNIX commands, and gives access via an application program interface (API) that allows C/C++ programmers to access a limited number of methods of the program.

With release 8.5 of the IBM Information Server™ suite, features were added to the DataStage™ application, allowing the check-in and check-out of source code into two source control applications: IBM Rational ClearCase™ and Concurrent Versions System™ (CVS), directly from the graphical user interface (GUI) of DataStage™. However, this feature does not serve as a release management application as it does not allow for example the deployment of packages or bundles of programs, from the release management application itself.

IBM has recently developed an application suite called Jazz Rational Team Concert™ or Jazz RTC™ (http://jazz.net) whose mission is to enable closer collaboration between the various units of a development team such as business analysts, architects, developers and other manager types. Jazz RTC™ contains several modules, including one for managing source control and release management. However, this application has been designed for common text-based programming, as for previously stated solutions, and is therefore not readily integrated with DataStage™.

As ETL programming is a particular niche of information technology and as software source control and release management applications are designed to handle the integration of a wide range of applications, no custom module fitted for a single program such as DataStage™ is known to the applicant.

Hence, in light of the aforementioned, there is a need for an improved system which, by virtue of its design and components, would be able to overcome some of the above-discussed prior art concerns.

### SUMMARY OF THE INVENTION

The object of the present invention is to provide a solution which better integrates write-protected and/or complex programs, such as DataStage™, in a suite of release management and source control, and is thus an improvement over other related version control or release management systems and/or related methods known in the prior art.

In accordance with the present invention, the above mentioned object is achieved, as will be easily understood, by a version control system and method such as the one briefly described herein and such as the one exemplified in the accompanying drawings.

In accordance with an aspect of the invention, there is provided a method for managing versions of program assets of a library, each of said program assets having source code which is protected, the method being executable by a single utility application having an integration module which is embedded in a processor, the method comprising the steps of:
i) receiving a selection of one or more program asset to be exported into the utility application for storage;
ii) extracting from the library and into a digest, for each of the one or more program asset selected, instructions for building the source code of the corresponding program asset, by means of the integration module;
iii) storing, by means of the integration module, each digest as a new instance of the digest in a data storage;
iv) associating in the data storage, by means of the integration module, a new version identifier to each new instance of digest, the new version identifier representing a new version of the corresponding program asset; and
v) in the data storage, associating a checked-in status to each new instance of digest stored at step (iii), by means of the integration module, to indicate that each of said new instance of digest is stored in the utility application.

In a particular embodiment of the above-mentioned aspect, the data storage comprises a plurality of said digests, each digest comprising instructions to rebuild a corresponding program asset in the library, the method further comprising:
vi) receiving, via a user interface, a selection of one or more of said program assets to be imported into the library and the corresponding version information;
vii) retrieving an instance of the digest from the data storage for each of said one or more program asset to be imported, by means of the integration module, being associated to the version information received at step (vi); and
viii) for each digest retrieved at step (vii), executing the instructions to rebuild the corresponding program asset, by means of the integration module, in order to import a new version of the corresponding program asset into the library.
ix) in the data storage, replacing a checked-in status associated each instance of the digest retrieved at step (vii) with a checked-out status, by means of the integration module, to indicate that the corresponding one or more program asset is currently being updated.

In another particular embodiment of the above-mentioned aspect, the data storage comprises a plurality of said digests, each digest comprising instructions to rebuild a corresponding program asset in the library, the data storage storing multiple instances of at least one of the digests, each instance corresponding to a version of the corresponding program asset, the method further comprising:
receiving a selection of two or more digest instances of the data storage and corresponding version identifier, to be compared;
retrieving from the data storage the instances of the digest corresponding to the selection received;
by means of the integration module, comparing the content of the digest instance, to generate comparison information; and
returning the comparison information on a user interface component.

In accordance with another aspect of the present invention, there is provided a system for managing versions of program assets of a library, each of said program assets having source code which is protected, the system comprising:
a user interface for receiving a selection of one or more program asset to be exported into a utility application for editing;
an integration module embedded in a processor which is in communication with the user interface, the integration module comprising an exportation module for extracting from the library into a digest, for each of the one or more program asset selected, instructions for building the source code of the corresponding program asset; and
a data storage, in communication with the integration module, for storing each digest as a new instance of the digest, and for associating a new version identifier to each new instance of digest, the new version identifier representing a new version of the corresponding program asset, and for further associating a checked-in status to each new instance of digest stored to indicate that each of said new instance of digest is stored in the utility application.

In accordance with another aspect of the present invention, there is provided a storage medium for managing versions of program assets of a library, each of said program assets having source code which is protected, the storage medium being processor-readable and non-transitory, the storage medium comprising instructions for execution by a processor, via a single utility application, to:
i) receive a selection of one or more program asset to be exported into the utility application for storage;
ii) extract from the library and into a digest, for each of the one or more program asset selected, instructions for building the source code of the corresponding program asset, by means of the integration module;
iii) store, by means of the integration module, each digest as a new instance of the digest in a data storage;
iv) associate in the data storage, by means of the integration module, a new version identifier to each new instance of digest, the new version identifier representing a new version of the corresponding program asset; and
v) associated, in the data storage, a checked-in status to each new instance of digest stored at (iii), by means of the integration module, to indicate that each of said new instance of digest is stored in the utility application.

### Program Asset Export (“Check-in” to the Version Control System)

In accordance with another aspect of the invention, there is provided a method for exporting a program asset from an extract-transform-load (ETL) library storing a plurality of said program assets, each program asset being protected in the ETL library, the method comprising steps of:
a) receiving, via a user interface, a command for exporting said program asset;
b) exporting, by means of an integration module, the program asset from the ETL library into a digest, the digest comprising instructions for rebuilding the program asset in the ETL library;
c) storing, by means of the integration module, a new instance of the digest in the data storage;
d) associating in the data storage, by means of the integration module, a new version to said new instance of the digest; and
e) by means of the integration module, setting a checked-in status to the new instance of the digest in the data storage.

In a particular embodiment of the above-mentioned aspect, step (d) of the method includes:
querying the data storage to locate an instance of the digest being associated to a latest version of the digest; and
if no instance of the digest is located in the data storage, said new version is a first version, and otherwise, said new version is obtained by incrementing an originating version associated to the digest.

In accordance with particular embodiments of the present invention, rules are defined in the integration modules which increment the version based on allowed increases.

For example, when a version to check-in is the highest, major updates increment the first digit (1.0 to 2.0), while minor updates update the second digit (3.3 to 3.4). When checking-in an intermediate version, a major update upgrades the second digit (4.1.2 to 4.2.0) and minor updates increment the third digit (5.3.4 to 5.3.5). A fourth level of change could be implemented on customer request for specific needs.

In a particular embodiment of the above-mentioned aspect, instances of digests are organized in a tree defining branches, each branch for a given digest representing a subset of versions of the corresponding program asset. In this particular embodiment, the method further includes prior to step (d), receiving branch information identifying a selected branch in the data storage to which the new instance of the digest is to be associated to, and said new version of step (d) is assigned based on said selected branch.

In accordance with another aspect of the present invention, there is provided a method for exporting one or more program asset from an ETL library storing a plurality of said program assets, each program asset being protected in the ETL library, the method comprising steps of:
a) receiving, via a user interface, a command for exporting said one or more program asset;
b) exporting, by means of an integration module, the one or more program asset from the ETL library into respective one or more digest, each digest comprising instructions for rebuilding the corresponding program asset in the ETL library;
c) storing, by means of the integration module, a new instance of each of the one or more digest in the data storage;
d) associating in the data storage, by means of the integration module, a new version to each of said new instance; and
e) by means of the integration module, setting a checked-in status to the new instance of each of the one or more digest in the data storage.

In accordance with another aspect of the present invention, there is provided a version control system for an ETL library adapted to store a plurality of protected program assets, each of the protected program assets being exportable in the format of a digest of instructions for rebuilding the corresponding program asset, the version control system comprising:
a user interface for exchanging information with a user;
a data storage for storing instances of said digests of program assets and corresponding version information; and
an integration module being in communication with the user interface, with the storage module and with the ETL library, in order to generate a digest from said ETL library upon receiving a corresponding command from the user interface, to generate corresponding version information and to store said digest and version information in the data storage.
   Program Asset Import (“Check-Out” from the Version Control System)

In accordance with another aspect of the present invention, there is provided a method for importing a versioned program asset into an ETL library from a data storage, said program asset being buildable in the ETL library from a corresponding digest of instructions, one or more instance of said digest being stored in the data storage, each instance being associated to a version of the digest, the method comprising steps of:
a) receiving, via a user interface, a command for importing said program asset;
b) receiving, via the user interface, version information of the program asset to be imported;
c) retrieving an instance of the digest from the data storage, by means of an integration module, in accordance with the version information received at step (b);
d) by means of the integration module, setting a checked-out status to the instance of the digest in the data storage; and
e) executing the instructions of said instance of the digest (to build the corresponding program), by means of the integration module, in order to import the corresponding program asset in the ETL library.

In a particular embodiment of the above-mentioned aspect, the method further comprises after step (c), validating whether said instance of digest retrieved at step (c), has a checked-out status, and only if the program asset does not have a checked-out status, proceeding to the following steps of the method.

In a particular embodiment of the above-mentioned aspect, instances of digests are organized in a tree defining branches, each branch for a given digest representing a subset of versions of the corresponding program asset. In this particular embodiment, the version information received at step (b) further includes branch information, and the retrieving of step (c) takes into account the branch information.

### Package Creation and Deployment

In accordance with another aspect of the present invention, there is provided a method for importing a package of versioned program assets into an ETL library from a data storage, each of said program asset being buildable in the ETL library from a corresponding digest of instructions, one or more instance of said digest being stored in the data storage, each instance being associated to a version of the digest, the method comprising steps of:
a) receiving, via a user interface, a command for importing a new package;
b) receiving, via the user interface, the program assets to be imported via the new package and corresponding version information;
c) generating the new package in the data storage, by means of the integration module;
d) retrieving from the data storage, instances of the digests corresponding to the program assets to be imported, by means of the integration module, in accordance with the version information received at step (b);
e) associating in the data storage, the instances retrieved at step (d) with the new package;
f) by means of the integration module, setting a deployment status to the new package in the data storage; and
g) executing the instructions of each of said instances associated to the new package, by means of the integration module, in order to import the corresponding program assets in the ETL library.

In a particular embodiment of the above-mentioned aspect, the one or more instance of the digest are grouped by branches in the data storage, each branch corresponding to a subset of versions of the digest. In this particular embodiment the version information received at step (b) further includes branch information, and the retrieving of step (c) is takes into account the branch information.

### Version Comparison

In accordance with another aspect of the present invention, there is provided a method for comparing versions of a given program asset in an ETL library, the given program asset being protected and buildable from a digest of instructions stored in a data storage, the data storage storing multiple instances of the digest, each instance corresponding to a version of the given program asset, the method comprising steps of:
a) receiving, via a user interface, instructions to compare two versions of said given program asset of the ETL library;
b) retrieving from the data storage, by means of an integration module, two instances of the digest corresponding to said two versions of said given program asset;
c) by means of an integration module, generating comparison information, by pairing matching components of the two instances; and
d) returning, by means of the integration module, the comparison information on the user interface.

### TERMINOLOGY

In the context of the present invention, a “program asset” (also referred to herein as an “asset” or “component”) may be a DS job (Datastage™ program), a routine, a data connection, and/or any other unitary component that may be exported from the ELT library (example: Datastage™) and versioned independently.

In the context of the present invention, each of said “integration module”, “ETL library” and “data storage” is located on a server or a plurality of server(s). It is to be understood that two or more of said “integration module”, “ETL library” and “database” may share one or more same server(s).

An “ETL library”, in the context of the present invention, refers to an ETL system such as the Datastage™ tool, for example, including the program assets it defines for a given project within a particular development environment (development, testing, production, etc.). In the context of Datastage™, program assets are each defined by a plurality of “artifacts” which may include source code, an object, an instruction, a graphical component, etc. in the form of a file, table, a pointer or reference, or portion thereof for example, which read-protected and write-protected.

A “digest” (also referred to herein as “summary”), in the context of the present invention, may be a file or group of files and/or the like, comprising a set of instructions to build an instance of the corresponding program asset in the ETL library. Thus, with said digest, an instance of the program asset is built in a format which can be independently stored by a user (i.e. a developer).

In the context of the present invention, the expressions “source control”, “revision control”, “version control”, “release management”, “source management program”, “source control application”, “source program”, and/or the like, as well as compound terms thereof, are used interchangeably.

### OTHER ASPECTS OF THE INVENTION

In accordance with another aspect of the invention, there is provided a method for exporting a program component from a library of program components, the library storing artefacts, each program component being defined by a plurality of said artefacts, the method comprising steps of:
a) extracting from the library, a digest of the artifacts being associated to the program component to be exported, the digest comprising instructions for rebuilding the program component in the library;
b) storing the digest in a data storage; and
c) associating version data to said digest in the data storage, said version data being indicative of a new version of the program component.

In a particular embodiment of the present invention, the steps of the above-method are performed by means of an integration module being in communication with the library, the data storage and the user interface.

In accordance with another aspect of the invention, there is provided a version control method for a library of protected program components, each program component being convertible into a digest comprising instructions for building the corresponding program component, the method comprising steps of:
a) generating a digest of one of said program components, the digest comprising instructions for rebuilding the program component in the library;
b) storing the digest in a data storage; and
c) associating version data to said digest in the data storage, said version data being indicative of a new version of the program component.

In accordance with another aspect of the invention, there is provided a version control system for controlling versions of a program component of a library of said program components, each program component being protected in the library and being further convertible into a digest comprising instructions for building the corresponding program component, said version control system comprising:
a) a user interface for exchanging data with a user;
b) a data storage for storing version data related to said program component of the library;
c) an integration module being in communication with the user interface for receiving a user command to generate a new version of one of said program components, the integration module being in communication with the library of program components for extracting therefrom an instance of a digest corresponding to said program component and for associating thereto a new version, the integration module being further in communication with the data storage for storing therein said instance of the digest and the new version.

In accordance with yet another aspect of the invention, there is provided a version control system for controlling versions of program components of a library of said program components. Each program component is either protected in the library or defined by a plurality of artifacts accessible by the library. Each program component is further convertible into a digest of instructions for rebuilding the corresponding program component in the library. The version control system comprises:
a) a user interface for exchanging data with a user;
b) a data storage for storing instances of digests corresponding to the program components, and for storing version data related each instance of said digest, each instance of said digest representing a version of said program component of the library;
c) an integration module being in communication with the user interface for receiving a user command and with the data storage in order to interact with the data storage, based on the user command.

In accordance with another embodiment of the present invention, there is provided a computer readable storage medium having stored thereon, data and instructions for performing one or more of the above-mentioned methods.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a screen shot of graphical components defining a program in the Datastage environment, in accordance with the prior art.

FIG. 2A is a flow chart showing the manual steps carried out in exporting a Datastage™ program, in accordance with the prior art.

FIG. 2B is a flow chart showing the manual steps carried out in importing a program into a Datastage™ project, in accordance with the prior art.

FIG. 3 is a bloc diagram illustrating a data flow between the Datastage™ environments and a source control application, in accordance with the prior art.

FIG. 4 is a schematic diagram showing a three-tier architecture of a version control system, namely, a user interface, a coordinating module (or “logical layer”) and database, in accordance with an embodiment of the present invention.

FIG. 5 is a schematic diagram showing a Linux-Apache-MySQL-PHP (LAMP) configuration of the user interface shown in FIG. 4.

FIG. 6 is a schematic diagram representing an ETL axis, a user interface axis and a database axis of the version control system shown in FIG. 4.

FIG. 7 is a hierarchical class diagram showing classes and subclasses of the ETL axis represented in FIG. 6.

FIG. 8 is a hierarchical class diagram showing classes and subclasses of the database axis represented in FIG. 6.

FIG. 9 is a data model showing the tables of the database represented in FIG. 6.

FIG. 10 is a sequence diagram of steps performed by the version control system, for checking-in a component, according to an embodiment of the present invention.

FIG. 11 is a sequence diagram of steps performed by the version control system, for checking-out a component, according to an embodiment of the present invention.

FIG. 12 is a sequence diagram of steps performed by the version control system, for creating and deploying a package, according to an embodiment of the present invention.

FIG. 13 is a sequence diagram of steps performed by the version control system, for comparing versions of a component, according to an embodiment of the present invention.

FIG. 14 is a bloc diagram of a system in accordance with an embodiment of the present invention.

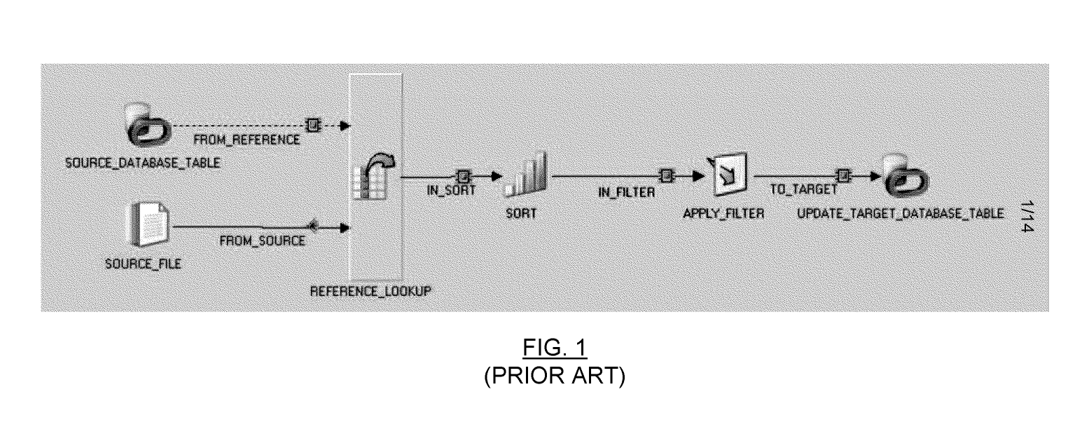

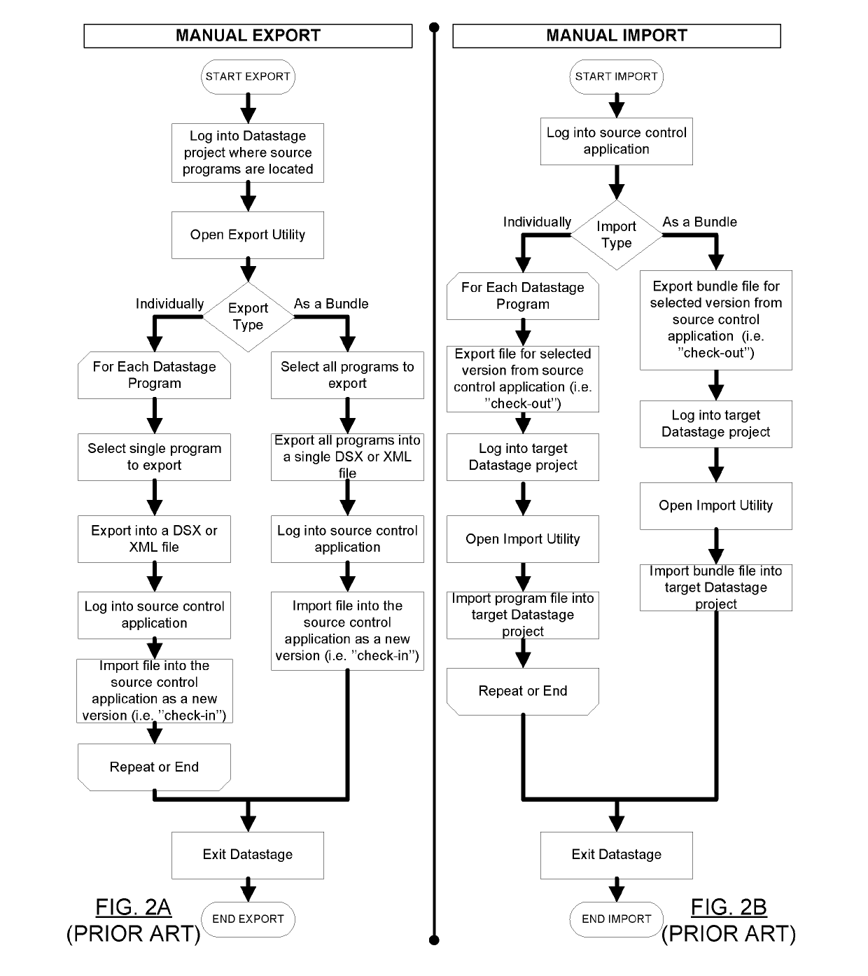

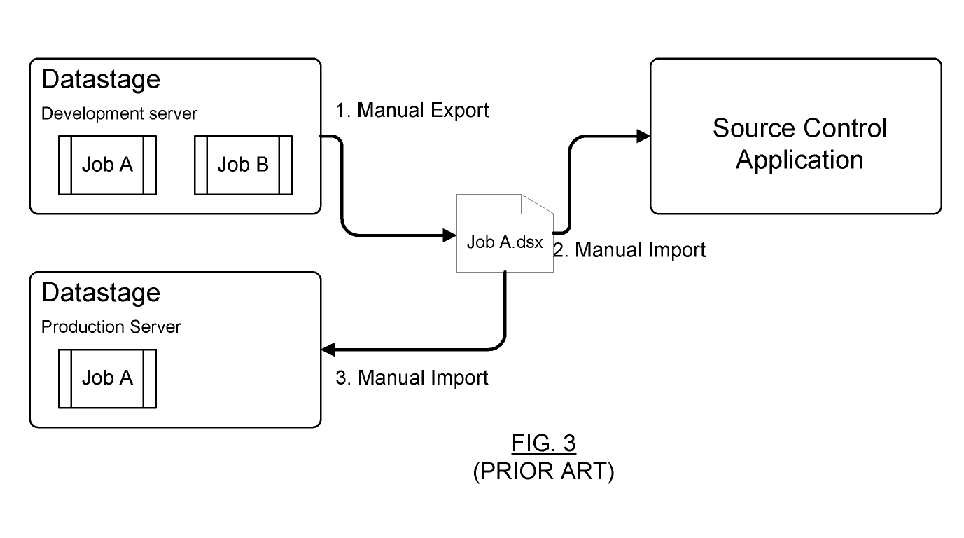

### DETAILED DESCRIPTION OF PREFERRED EMBODIMENTS OF THE INVENTION

In the following description, the same numerical references refer to similar elements. The embodiments mentioned and/or configurations and architecture shown in the figures or described in the present description are embodiments of the present invention only, given for exemplification purposes only.

Broadly described, the present invention according to a preferred embodiment thereof, as exemplified in the accompanying drawings, is a version control system for a IBM Infosphere Datastage™ framework.

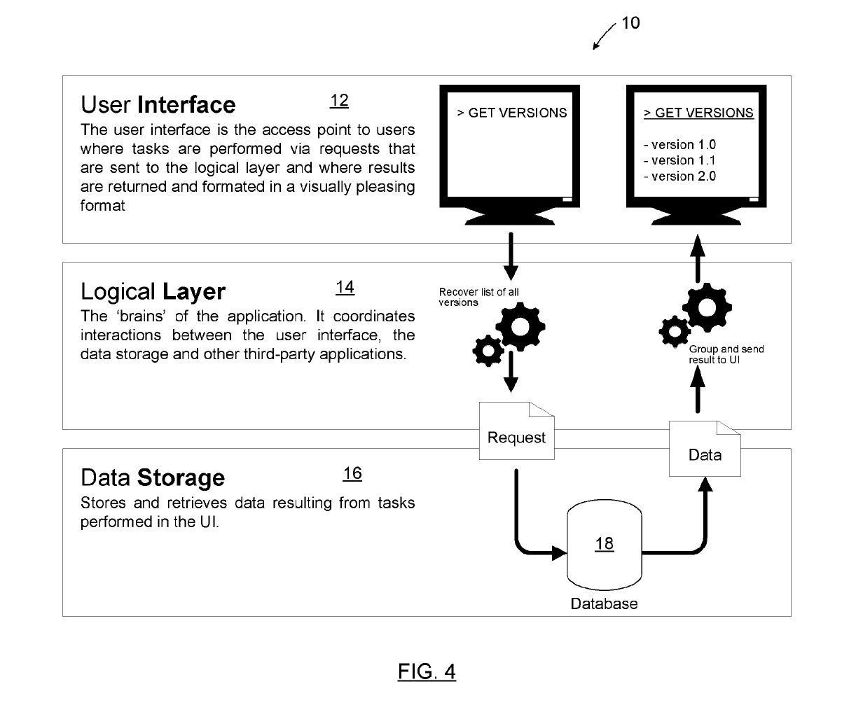

As better illustrated in FIG. 4, the version control system 10, in accordance with an embodiment of the present invention, is designed following a three-tier architecture, namely comprising: a user interface 12 (also referred to herein as “UI”), a logical layer 14 (also referred to herein as the “integration module”) and a data storage 16 provided by a database 18.

### Three-Tier Architecture: 1. User Interface

### Model

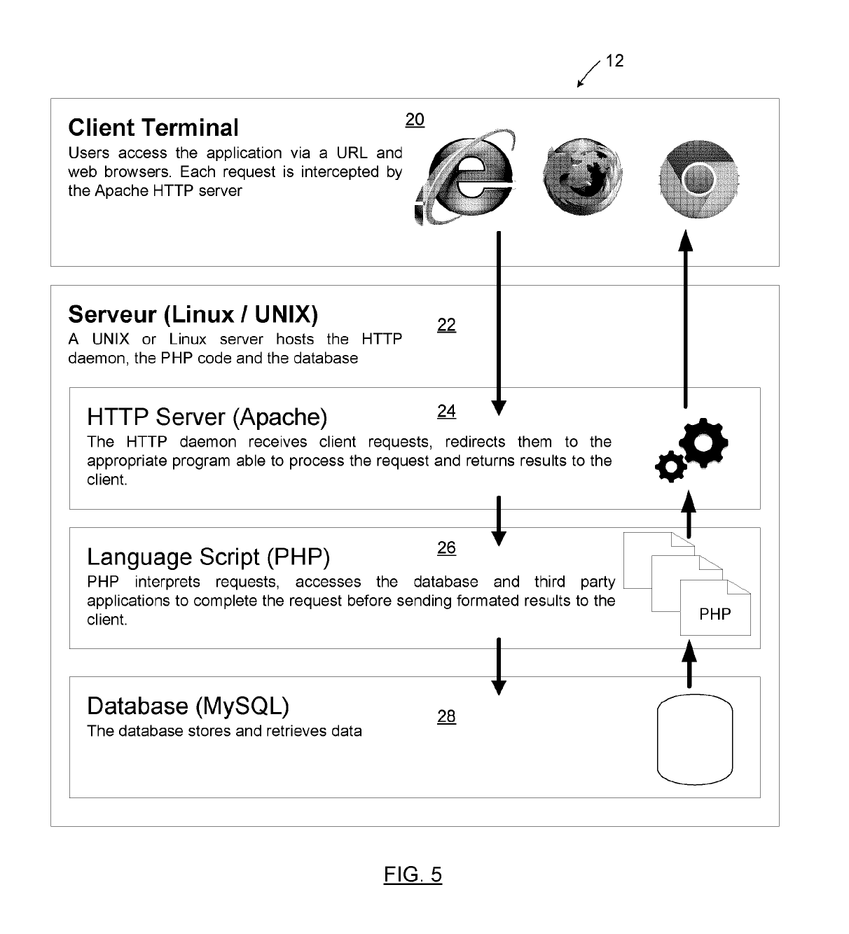

In accordance with the present embodiment, the user interface model is very similar to a LAMP platform (Linux-Apache-MySQL-PHP) for use in conjunction with web browsers located on client terminal 20. A LAMP configuration is exemplified in FIG. 5. The source program interface resides on a Unix server 22. An Apache HTTP server 24 acts as a bridge between the source program 14 and user requests. The user interface code 26 is written in PHP and the data specific to the interface such as user accounts, images and configurations are stored in a MySQL database 28.

### Site Plan

The user interface comprises four (4) main windows, presenting functionalities which may be summarized as follows:
1. Login window:
   a. To create a user account
   b. To retrieve a lost password
   c. To access the program after successful login
2. Version Control Management window:
   a. For creating, maintaining and accessing versions of DataStage™ programs.
   b. To consult the history and metadata of a program
   c. To create reports on programs
3. Release Management window:
   a. To Create and maintain packages of program versions
   b. To deploy packages in environments
   c. To consult release history
   d. To create reports on releases
4. Administration window:
   a. To manage users, roles and responsabilities
   b. To create and maintain branches and foundation components to versions and releases.
   c. To configure connection settings for DataStage™ servers and environments

The Unix server 22 designated to host the user interface is preferably provided by client users. The Apache HTTP Server, the MySQL database and PHP development framework are licensed under open source and are freely available.

### Three-Tier Architecture: 2. Logical Layer

### Model

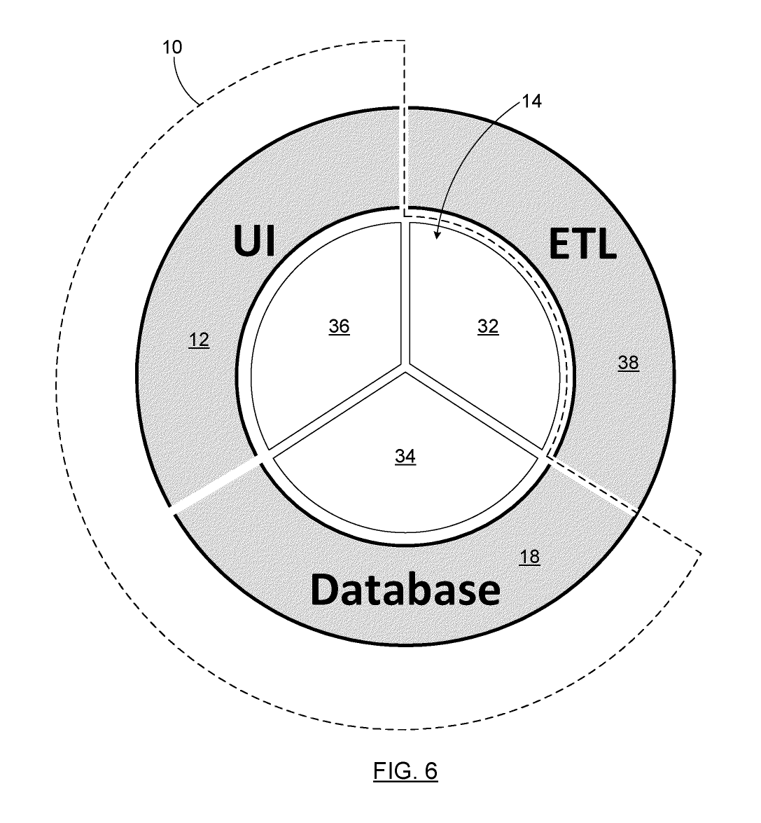

The pie chart shown in FIG. 6, illustrates three main class segments 32, 34, 36 of the version control system 10 of the present embodiment.

Programmed in object-oriented C++, the logical layer 14 contains classes and methods 32 interacting with DataStage™ (i.e. ETL) 38. The logical layer 14 further comprises classes and methods 34 interacting with the database 18 containing versioned source code and other artefacts. The logical layer 14 further comprises classes and methods 36 interacting with the user interface 12. Compiled into a library, the logical layer 14 may be source code protected to avoid accessibility to customers.

### ETL Axis

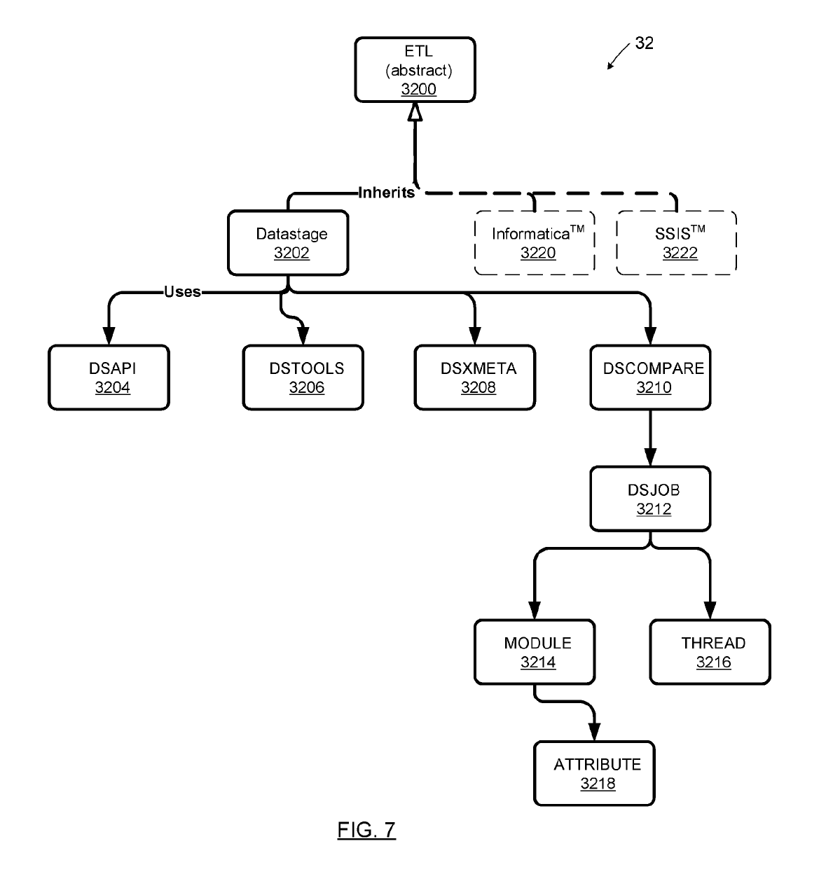

The ETL Axis or “class segment” 32 contains classes interacting with the DataStage™ software and/or with other ETL tools. The classes and subclasses of the ETL axis 32, namely for DataStage™, will now be described with reference to FIG. 7.

### Class Details

Abstract ETL class (3200). The embodiment described herein is intended to target IBM Infosphere DataStage™ programs as well as other ETL suites (for example Informatica™ 3220 or SSIS™ 3222). For this reason, an abstract class ETL 3200 is defined above the DataStage class 3202.

DataStage class (3202). This class 3202 inherits from the abstract ETL class 3200 to instantiate an object of type DataStage™. It does not directly interface with DataStage™. To do this, each object will instantiate four objects: a DSAPI class 3204 to access methods for the API methods offered by DataStage™, a DSTools class 3206 to export and import ETL programs and components, a DSXmeta object 3208 to query the DataStage™ database and finally, and a DSCompare class 3210 to analyze and compare different versions of an ETL program.

DSAPI class (3204). The DSAPI class 3204 allows access to methods made available by the DataStage™ API. The API is offered by DataStage™ to allow access to certain internal methods of the application. It allows among other things to list projects and programs. It also allows controls over the execution of programs. Embodiments of the present invention are intended to further enable the management of program executions, for example, via methods provided by the Datastage API in order to launch the execution of Datastage™ programs.

DSTools class (3206). DataStage™ provides ways to extract and create or replace programs by means of DOS or UNIX commands under either Windows or Unix. This class 3206 contains the methods required to automate these function calls.

DSXmeta class (3208). The DSXmeta class 3208 queries the DataStage™ database directly. It can extract the list of ETL programs of an object and other useful data. Embodiments of the present invention are intended to lock programs for editing, thus acting as a “check-out” feature, preventing changes in applications without having first reserved a version of a program in the integration module.

DSCompare class (3210). The data files extracted from DataStage™ for versioning do not represent the source code data but rather a list of instructions to build an instance of a program. This can be likened to a Lego block montage and its set of instructions. Commonly, software versioning would keep a copy of the actual finished product. Because of current DataStage™ constraints, only the instructions can be versioned. DataStage™ protects direct access to source code and provides only a summary of the program in a proprietary format called dsx or in the form of XML. The instructions contained in a summary are complex and contain not only the business rules, but since ETL program is graphical, the summary also contains all data relating to the positioning, size and alignment of each object and links. Comparison of two evolutions (or versions) of a DataStage™ program is rarely useful and provides virtually no information of interest. A DataStage™ “program” is also referred to as a Datastage™ “job”, and corresponds to an “asset” or “component” in the context of the present description. This class 3210 provides methods for analyzing summary files and translate the results into quantity of objects each in turn containing instances of other child objects of different classes with specific properties. Once analyzed, two summaries could then be compared by isolating and comparing each sub-component programs. Different levels of comparison may be provided, in according with embodiments of the present invention, ranging from surface analysis (where only the presence and names of modules and children are compared) to in-depth analysis, where the positioning and alignment of components are also considered.

DSJob class (3212). When analyzing a program summary, an object of this class 3212 represents an ETL program. The latter may consist of objects of the Module class 3214 and Thread class 3216.

Module class (3214). This class 3214 represents a processing block in a DataStage™ program. It can be passive if it only reads or writes data from files or databases or active if it applies transformations to the data. Business rules application, sorting, filters and data aggregation are some of the operations performed by a module. Each module contains objects of the Attribute class.

Attribute class (3216). An object of the Attribute class defines an attribute of a record that is subject to any kind of transformation.

Thread class (3218). A thread connects two modules together and incidentally allows data flow. Each thread contains one input port and one output port. Each port is connected to a module. This class is used to record data transmitted between each module of a program.

### Database Axis

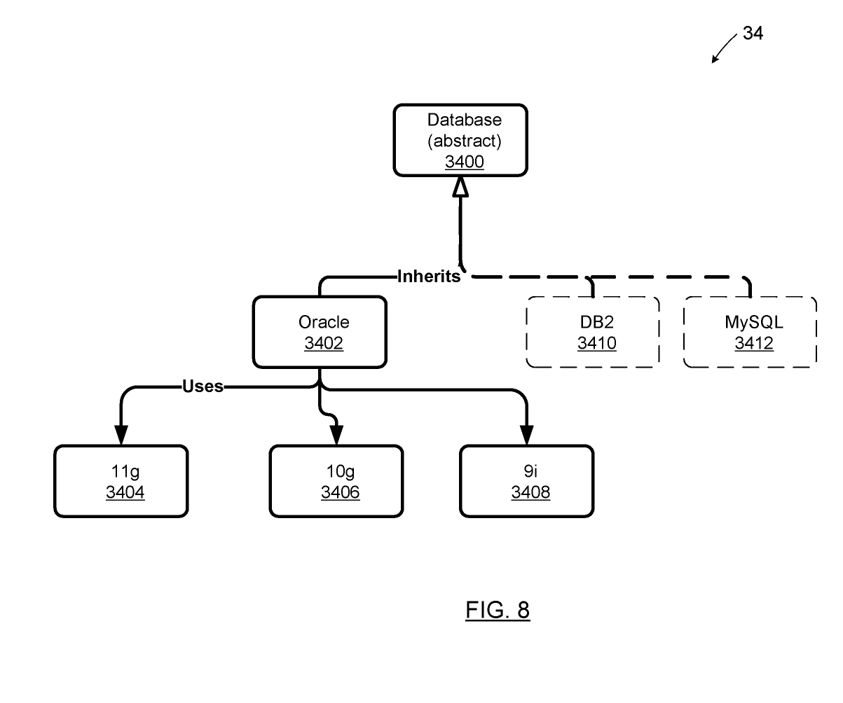

The classes in the database segment 34 allow interactions with the database 18 where versions of components and other artefacts are stored. The classes and subclasses of the Database axis 34, namely for the Oracle™ database, will now be described with reference to FIG. 8.

Abstract Database class (3400). Although Oracle is the solution of choice for most DataStage™ users, some customers might be using DB2 or some other database product, such as DB2 3410, MySQL 3412 and/or the like. Thus, an abstract class exists above the Oracle class to allow integration of different databases. The database class provides data storage and retrieval.

Abstract Oracle (3402). This class inherits from the Database class and allows the storage and retrieval of source code under an Oracle database. It is not designed to instantiate objects but to allow the creation of objects of child classes for specific versions of Oracle.

Oracle11g class (3404). This class 3404 inherits from the abstract class Oracle 3402 and allows interaction with the Oracle Database 11g.

Oracle10g class (3406). This class 3406 inherits from the abstract class Oracle 3402 and allows interaction with the Oracle Database 10g.

Oracle9i class (3408). This class 3408 inherits from the abstract class Oracle 3402 and allows interaction with the Oracle 9i database.

### UI Segment

This class segment 36 interacts with the UI 12. It interprets requests from the presentation layer and returns results. At this stage of development, only one class is included in this segment.

UI class. A class of interaction with the user interface named UI will receive user requests, process these requests by calling methods of and ETL object and methods of a Database object.

### Main Methods Overview

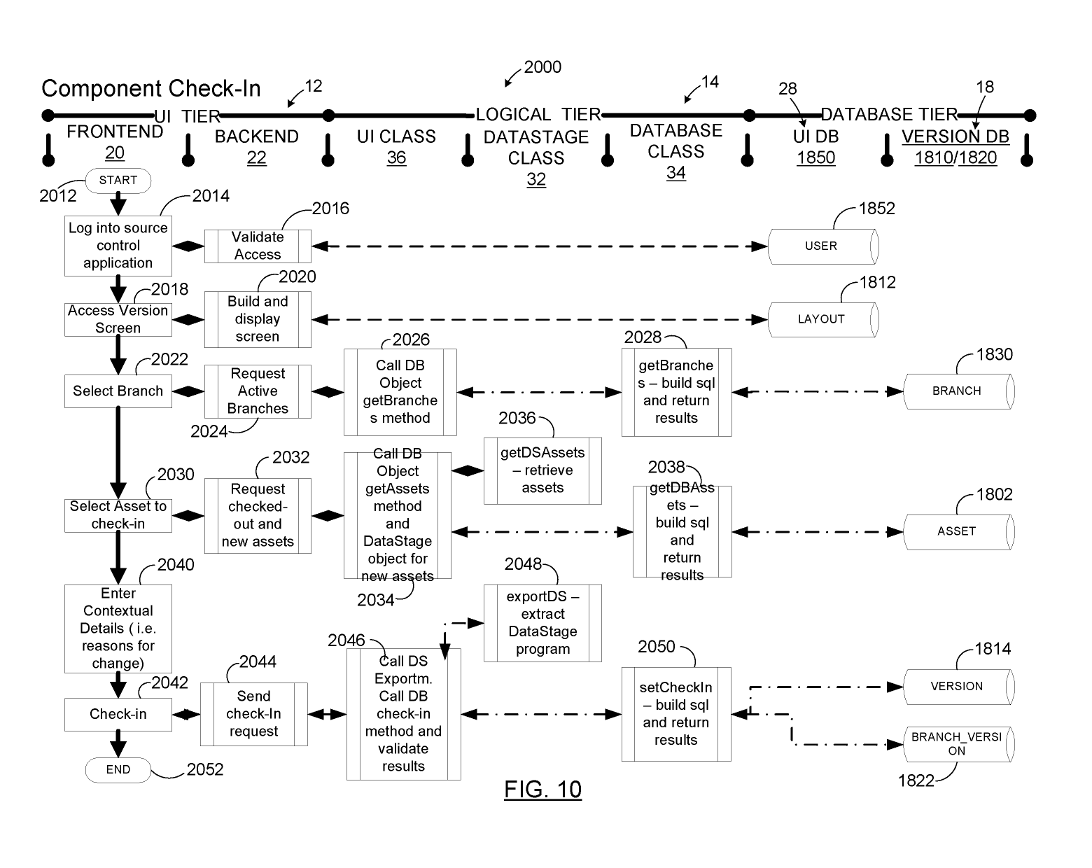

The main methods found under the UI class will be described further below, with reference to the flowcharts shown in FIGS. 10 to 13

### Three-Tier Architecture: 3. Database Layer

### Model

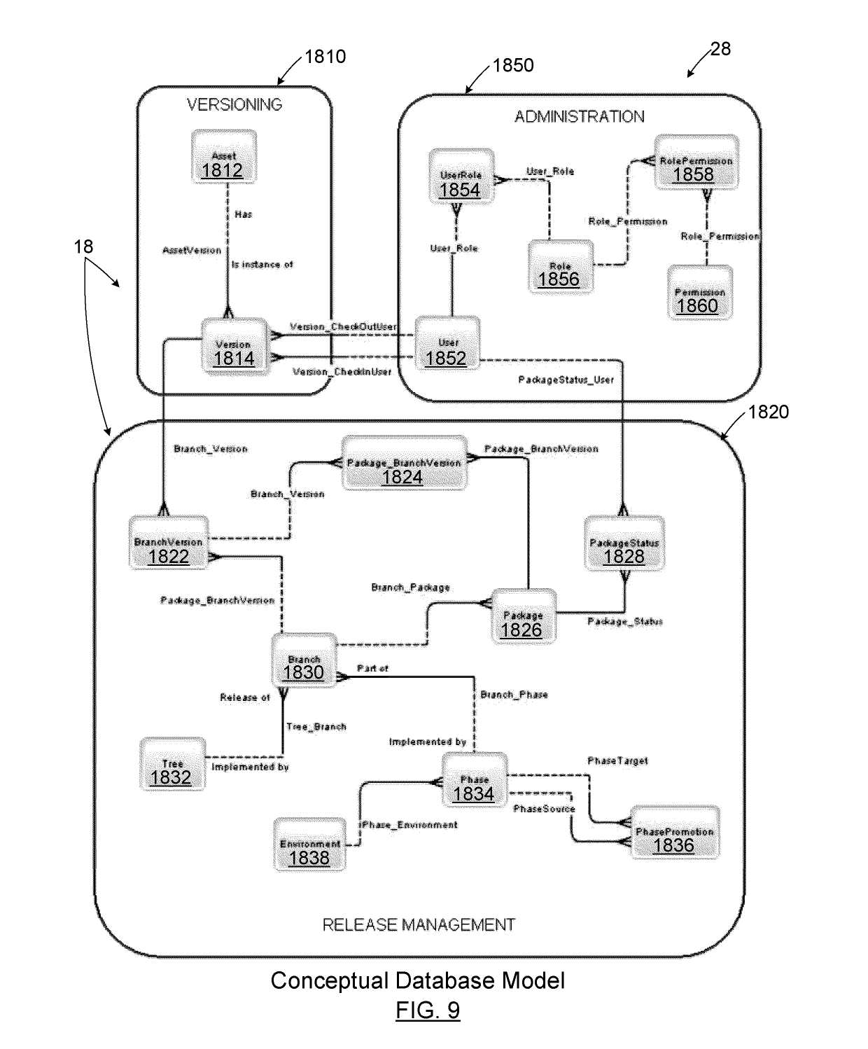

The database 18, better shown in FIG. 9, is a relational database and contains data related to version control 1810 and release management 1820. The database 18 cooperates with the UI database 28 (see FIG. 5) which includes administration data 1850, as illustrated in FIG. 9. Each table in the data model is detailed below with a summary and description of each column, in according with the present embodiment.

It is to be understood that the database 18, may include the administration data 1850 and/or the UI database 28, in accordance with alternative embodiments of the present invention.

Asset table (i.e. component). An Asset table 1802, having columns represented in TABLE 1 below, contains a list of each entity having at least one versioned instance. An asset may be a DSjob, a routine, a data connection, etc. In other words, any component that can be exported from Datastage™ as a unit.
A component must have at least one version.
A component can have multiple versions

TABLE 1

| | | | | | | |
|---|---|---|---|---|---|---|
| No | Name | Description | Type | pk | fk | Unique |

| | | | | | |
|---|---|---|---|---|---|
| 1 | Asset_Id | Unique | NUMBER | X | X |
| | | identifier | | | |
| 2 | Name | Entity Name | VARCHAR2(255) | | X |
| 3 | Type | Asset Type | VARCHAR2(50) | | |
| 4 | Status | Usage status | VARCHAR2(30) | | |

Version table. A Version table 1804 is represented in TABLE 2 below. Each version of an entity is a frozen image of a component code at specific point in time.
A version belongs to a single asset.
A version can be reserved (checked-out) by a single user.
A version must be associated with a user on creation.

TABLE 2

| No | Name | Description | Type | pk | fk | Unique |
|---|---|---|---|---|---|---|
| 1 | Version_Id | Unique identifier | NUMBER | X | | X |
| 2 | Asset_Id | Asset identifier | VARCHAR2(255) | | X | |
| 3 | Version | Version identifier | VARCHAR2(50) | | | |
| 4 | CheckOutStatus | Job reservation status | VARCHAR2(50) | | | |
| 5 | CheckOutUser_Id | Owner of reservation | NUMBER | | X | |
| 6 | Code | Actual DataStage ™ | BLOB | | | |
| | | program extraction file | | | | |
| 7 | Code_Format | Type of file (DSX or | VARCHAR2(50) | | | |
| | | XML) | | | | |
| 8 | CreatedBy | Creation user | NUMBER | | X | |
| 9 | BaseVersion_Id | Original version to | NUMBER | | X | |
| | | which changes were | | | | |
| | | made | | | | |

Table BranchVersion (version branch). A BranchVersion table 1822 is represented in TABLE 3 below and corresponds to an intersection table between versions and branches.
A version must belong to one or more branches.
A branch-version can be associated with any one or more packages.
A branch may be composed of multiple versions of different components.
Each component can be associated with a branch by only one of its versions.

TABLE 3

| No | Name | Description | Type | pk | fk | Unique |
|---|---|---|---|---|---|---|
| 1 | BranchVersion_Id | Unique | NUMBER | X | | X |
| | | identifier | | | | |
| 2 | Branch_Id | Branch | NUMBER | | X | |
| | | identifier | | | | |
| 3 | Version_Id | Version | NUMBER | | X | |
| | | identifier | | | | |

Table PackageBranchVersion (version of a set of deployment). A PackageBranchVersion table 1824 is represented in TABLE 4 below and corresponds to an intersection table between branch-versions and packages.

TABLE 4

| | | | | | | |
|---|---|---|---|---|---|---|
| No | Name | Description | Type | pk | fk | Unique |

| | | | | |
|---|---|---|---|---|
| 1 | BranchVersion_Id | BranchVersion identifier | NUMBER | X |
| 2 | Package_Id | Package identifier | NUMBER | X |
| 3 | Operation_Type | Operation type (insertion, | VARCHAR2(30) | |
| | | update, deletion) | | |

Table Package (Set of deployment). A Package table 1826 is represented in TABLE 5 below and identifies a group of asset versions to be deployed in a branch as a bundle.
A package contains a single version of an asset.
A package contains versions from a single branch.
A package can be deployed in a single branch
A package must contain at least one entry in the package status table.
A package may contain multiple entries in the package status table.

TABLE 5

| No | Name | Description | Type | pk | fk | Unique |
|---|---|---|---|---|---|---|
| 1 | Package_Id | Unique | NUMBER | X | | X |
| | | Identifier | | | | |
| 2 | Branch_Id | Branch iden- | NUMBER | | X | |
| | | tifier (where | | | | |
| | | deployed) | | | | |
| 3 | Name | Package | VARCHAR2(50) | | | |
| | | name | | | | |
| 4 | Description | Contextual | VARCHAR2(255) | | | |
| | | description | | | | |

Table PackageStatus (Status of deployment). A PackageStatus 1828 table is represented in TABLE 5 below. Records in this table keep a history of the changes in the status of a package.
A package status belongs to only one package.
A package status must refer to a single user.

TABLE 6

| No | Name | Description | Type | pk | fk | Unique |
|---|---|---|---|---|---|---|
| 1 | PackageStatus_Id | Unique identifier | NUMBER | X | | X |
| 2 | Package_Id | Package identifier | NUMBER | | X | |
| 3 | Status | Deployment status (New, | VARCHAR2(50) | | | |
| | | Pending Authorization, | | | | |
| | | Deployed, Cancelled) | | | | |
| 4 | Created_By | User who updated the status | NUMBER | | X | |
| 5 | Created_Dt | Record creation date | TIMESTAMP | | | |

Table Branch (Branch). A Branch table 1830 is represented in TABLE 7 below. A branch is an instance of a project phase: (i.e. development, unit testing, production, etc.)
A branch must belong to a tree.
A branch can only belong to one tree.
A package may have been deployed on a branch.
A branch must belong to a single development phase.

TABLE 7

| No | Name | Description | Type | pk | fk | Unique |
|---|---|---|---|---|---|---|
| 1 | Branch_Id | Unique identifier | NUMBER | X | | X |
| 2 | Tree_Id | Tree identifier | NUMBER | | X | |
| 3 | Phase_Id | Phase identifier | NUMBER | | X | |
| 4 | Version | Evolution number of the | VARCHAR2(10) | | | |
| | | branch in relation to | | | | |
| | | other branches of a | | | | |
| | | parent tree (1.0.0, | | | | |
| | | 2.1.5, etc.) | | | | |
| 5 | ReadOnlyStatus | Read only status | VARCHAR2(30) | | | |
| | | identifying a dead | | | | |
| | | branch. | | | | |

Tree table (Project). A Tree table 1832 is represented in TABLE 8 below and corresponds to an ETL project which groups common tasks.
A project must have at least one branch.
A project can have multiple branches.

TABLE 8

| | | | | | | |
|---|---|---|---|---|---|---|
| No | Name | Description | Type | pk | fk | Unique |

| | | | | | |
|---|---|---|---|---|---|
| 1 | Tree_Id | Unique identifier | NUMBER | X | X |
| 2 | Name | Project Name | VARCHAR2(50) | | |
| 3 | Status | Project Usage | VARCHAR2(30) | | |
| | | status | | | |

Phase table (Development Phase). A Phase table 1834 is represented in TABLE 9 below and corresponds to a step in the development cycle.
A phase can be represented by any one or more branches.
A phase must belong to a single development environment.
A phase may be referred to as the source of a phase promotion in zero, one or more phases of promotions.
A phase may be referred to as the target of a phase promotion in zero, one or more phases of promotions.

TABLE 9

| No | Name | Description | Type | pk | fk | Unique |
|---|---|---|---|---|---|---|
| 1 | Phase_Id | Unique | NUMBER | X | | X |
| | | identifier | | | | |
| 2 | Env_Id | Environment | NUMBER | | X | |
| | | identifier | | | | |
| 3 | Name | Phase name | VARCHAR2(30) | | | |
| 4 | Description | Phase | VARCHAR2(255) | | | |
| | | description | | | | |

PhasePromotion Table (Promotion Phase). A PhasePromotion table 1836 is represented in TABLE 10 below and identifies which phase jumps are allowed when promoting packages from branches (i.e. development to testing, testing to production).

TABLE 10

| No | Name | Description | Type | pk | fk | Unique |
|---|---|---|---|---|---|---|
| 1 | Promotion_Id | Unique identifier | NUMBER | X | | X |
| 2 | PhaseSrc_Id | Source phase | NUMBER | | X | |
| | | identifier | | | | |
| 3 | PhaseTrgt_Id | Target phase | NUMBER | | X | |
| | | identifier | | | | |

Table Environment (Development Environment). An Environment table 1838 is represented in TABLE 11 below and corresponds to a server instance in DataStage™ (for example, development or production).
An environment has one or more phases of development.

TABLE 11

| | | | | | | |
|---|---|---|---|---|---|---|
| No | Name | Description | Type | pk | fk | Unique |

| | | | | | |
|---|---|---|---|---|---|
| 1 | Environment_Id | Unique identifier | NUMBER | X | X |
| 2 | Domain | Server domain name | VARCHAR2(255) | | |
| 3 | Host | Server host name | VARCHAR2(255) | | |
| 4 | Port | Port number for | NUMBER | | |
| | | connexion to the server | | | |

User table (User). A User table 1852 is represented in TABLE 12 below and identifies user accounts.
A user can be the creator of zero, one or more versions.
A user can be associated to a checked-out version
A user can be associated to a package status update

TABLE 12

| | | | | | | |
|---|---|---|---|---|---|---|
| No | Name | Description | Type | pk | fk | Unique |

| | | | | | |
|---|---|---|---|---|---|
| 1 | User_Id | Unique | NUMBER | X | X |
| | | identifier | | | |
| 2 | FirstName | User last name | VARCHAR2(50) | | |
| 3 | LastName | User last name | VARCHAR2(50) | | |
| 4 | ActiveStatus | User status | VARCHAR2(30) | | |

UserRole table (User Role). A UserRole table 1854 is represented in TABLE 13 below and corresponds to an intersection table connecting a user to roles and roles to users.
A user must occupy at least one role, but can occupy several.
A role can be associated with any one or more users.

TABLE 13

| | | | | | | |
|---|---|---|---|---|---|---|
| No | Name | Description | Type | pk | fk | Unique |

| | | | | |
|---|---|---|---|---|
| 1 | User_Id | User identifier | NUMBER | X |
| 2 | Role_Id | Role identifier | NUMBER | X |

Role Table (Role). A Role table 1856 is represented in TABLE 14 below. Each role can restrict tasks common to several users of the same type.

TABLE 14

| | | | | | | |
|---|---|---|---|---|---|---|
| No | Name | Description | Type | Pk | Fk | Unique |

| | | | | | |
|---|---|---|---|---|---|
| 1 | Role_Id | Unique | NUMBER | X | X |
| | | identifier | | | |
| 2 | Name | Role Name | VARCHAR2(50) | | |
| 3 | Description | Role | VARCHAR2(255) | | |
| | | Description | | | |
| 4 | ActiveStatus | Role Status | VARCHAR2(30) | | |

RolePermission table (Permission by role). A RolePermission table 1858 is represented in TABLE 15 below and corresponds to an intersection table connecting a role to permissions and a permission to roles.
A role can have zero, one or more permissions.
Permission may be associated with any one or more roles.

TABLE 15

| | | | | | | |
|---|---|---|---|---|---|---|
| No | Name | Description | Type | pk | fk | Unique |

| | | | | |
|---|---|---|---|---|
| 1 | Role_Id | Unique identifier | NUMBER | X |
| 2 | Permission_Id | Permission identifier | NUMBER | X |

Permission table. A Permission table 1860 is represented in TABLE 16 below. Each permission provides access to task or the visibility to certain views.

TABLE 16

| | | | | | | |
|---|---|---|---|---|---|---|
| No | Name | Description | Type | pk | fk | Unique |

| | | | | | |
|---|---|---|---|---|---|
| 1 | Permission_Id | Unique identifier | NUMBER | X | X |
| 2 | Name | Permission name | VARCHAR2(50) | | |
| 3 | Description | Description | VARCHAR2(255) | | |
| 4 | ActiveStatus | Usage status | VARCHAR2(30) | | |
| 5 | Type | Permission type | VARCHAR2(30) | | |
| | | (view, action) | | | |

### Main Functional Features

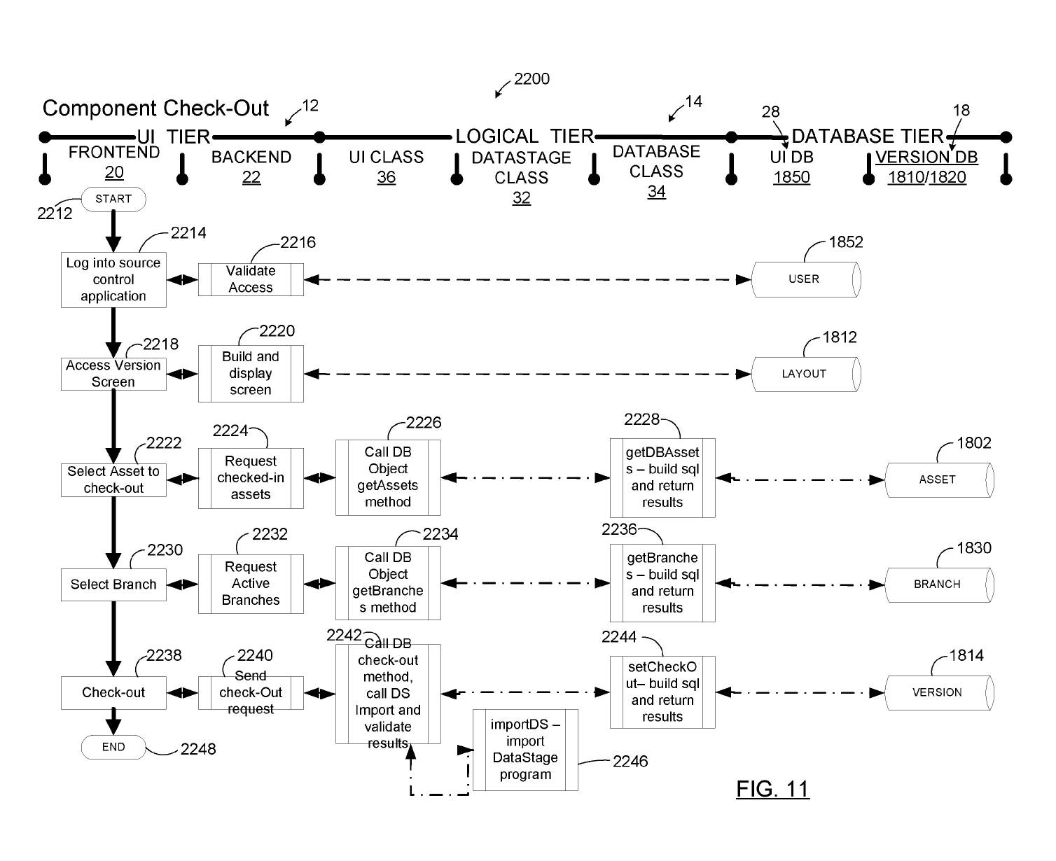

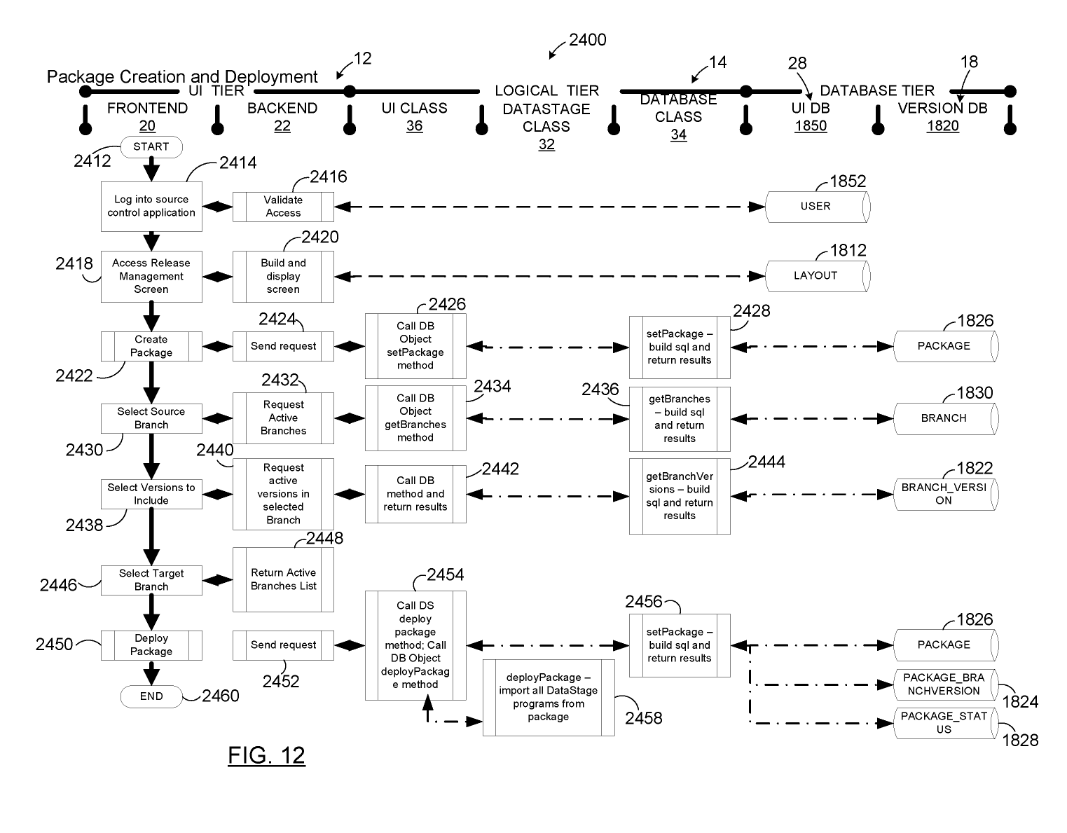

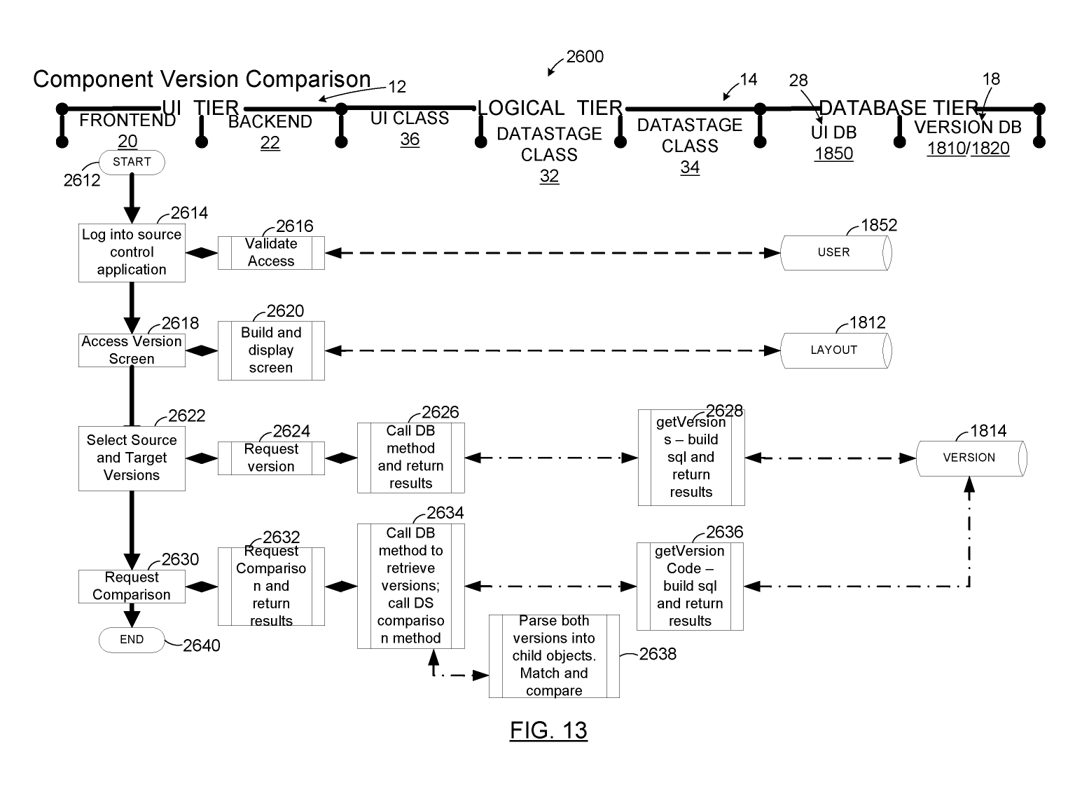

FIGS. 10 to 13 illustrate the interactions between the three (3) afore-mentioned tiers, for each of the main functions performed by the version control system, in accordance an embodiment of the present embodiment. The main functions illustrated are:
Checking-In of a DataStage™ component (see FIG. 10);
Checking-Out of a DataStage™ component (see FIG. 11);
Creation and Deployment of a package (see FIG. 12); and
Component Version Comparison (see FIG. 13).

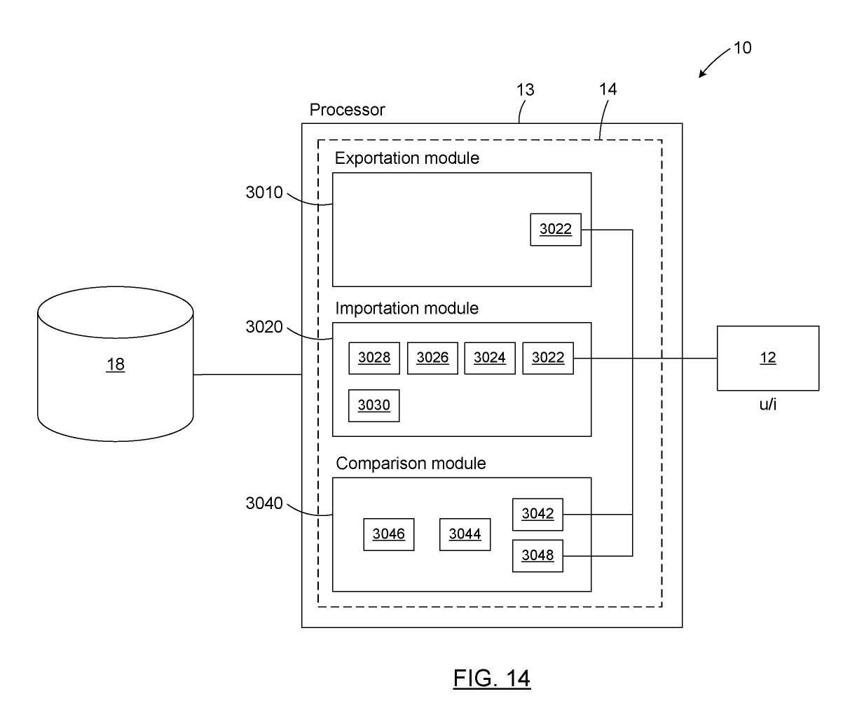

FIG. 14 shows the components of the system 10. As previously mentioned, the system 10 comprises a user interface 12, an integration module 14 and a data storage 16. The integration module 14 is embedded in a processor 13 and is comprised within a utility application for performing the steps of the methods described herein.

Referring to FIG. 10, there is shown a sequence diagram of steps performed by the version control system, for checking-in a component, according to an embodiment of the present invention.

Namely, a method 2000 for exporting a program asset from Datastage™ (i.e. ETL library) 38 is exemplified. The Datastage™ library 38 stores a plurality of said program assets, each program asset being protected in the Datastage™ library 38. The method 2000 comprises steps of:
a) receiving at 2034, via a user interface 12, a command for exporting said program asset;
b) exporting at 2048, by means of an integration module 14, the program asset from Datastage™ 38 into a digest, the digest comprising instructions for rebuilding the program asset in Datastage™ 38;
c) storing at 2050, by means of the integration module 14, a new instance of the digest in the database 18;
d) associating at 2050 in the database 18, by means of the integration module 14, a new version to said new instance of the digest by:
   querying the database 18 to locate an instance of the digest being associated to a latest version of the digest; and
   if no instance of the digest is located in the database 18, said new version is a first version, and otherwise, said new version is obtained by incrementing an originating version associated to the digest; and
e) by means of the integration module 14, setting at 2050 a checked-in status to the new instance of the digest in the database 18.

Instances of digests are organized in a tree defining branches. Each branch for a given digest represents a subset of versions of the corresponding program asset.

Thus, the method 2000 further includes prior to step (d):
receiving at 2026 branch information identifying a selected branch in the database 18 to which the new instance of the digest is to be associated to, and said new version of step (d) is assigned in association with said selected branch.

In FIG. 10, steps 2012, 2014, 2016 and table 1852 relate to user authentication; steps 2018, 2020 and table 1812 relate to accessing a screen on the user interface 12; steps 2022, 2024, 2026, 2028 and table 1830 relate to a branch selection; steps 2030, 2032, 2034, 2036, 2038, 2040 and table 1802 relate to the selection of asset(s) to check-into the system 10; steps 2042, 2044, 2046, 2048, 2050, 2052 and tables 1814 and 1822 relate to the extraction from the program assets to complete the exporting of the program asset(s).

It is to be understood that multiple program assets may be exported at once. It is to be understood that a plurality of digests may be stored in a single file corresponding to the multiple program assets, so long as each digest (i.e. each program asset) is associated to its own version information. Alternatively, each digest is stored in a separate file.

Thus, with reference to FIG. 14, the integration module 14 comprises an exportation module 3010 having an exportation communication port 3012 for communicating with the user interface 12.

Referring now to FIG. 11, there is shown a sequence diagram of steps performed by the version control system, for checking-out a component, according to an embodiment of the present invention.

Namely, a method 2200 for importing a versioned program asset into Datastage™ (i.e. ETL library) 38 from database 18 is exemplified. The program asset is buildable in Datastage™ 38 from a corresponding digest of instructions, one or more instance of said digest being stored in the database 18, each instance being associated to a version of the digest. The method 2200 comprises steps of:
a) receiving at 2226, via a user interface 12, a command for importing said program asset;
b) receiving at 2234, via the user interface 12, version information of the program asset to be imported;
c) retrieving at 2242 an instance of the digest from the database 18, by means of the integration module 14, corresponding to the version information received at step (b);
   validating at 2242 whether said instance of digest retrieved, has a checked-out status, and only if the program asset does not have a checked-out status, proceeding to the following steps of the method 2200:
d) at 2244, by means of the integration module 14, setting a checked-out status to the instance of the digest in the database 18; and
e) executing at 2246 the instructions of said instance of the digest, by means of the integration module 14, in order to import the corresponding program asset in the Datastage™ library 38.

In FIG. 11, steps 2212, 2214, 2216 and table 1852 relate to user authentication; steps 2218, 2220 and table 1812 relate to accessing a screen on the user interface 12 for prompting the check-out process; steps 2222, 2224, 2226, 2228 and table 1802 relate to the selection of asset(s) to check-out from the system 10; steps 2230, 2232, 2234, 2036, and table 1830 relate to a branch selection; steps 2238, 2240, 2242, 2246, 2244, 2248 and table 1814 relate to the rebuilding of the program assets to complete the importation into Datastage™.

It is to be understood that a single instance of digest may have either a checked-in status or a checked-out status at any given time. Indeed the checked-in and checked-out status are mutually exclusive.

Instances of digests are organized in a tree defining version branches, each version branch for a given digest representing a subset of versions of the corresponding program asset. Thus, the version information received at step (b) (2234) further includes branch information, and the retrieving of step (c) takes into account the branch information.

Thus, with reference to FIG. 14, the integration module 14 comprises further comprises an importation module 3020 comprising an importation input port 3022 for receiving the selection of program asset(s) to be imported into the library and the corresponding version information; a collector 3024 for retrieving an instance of the digest from the data storage for each the program asset(s) to be imported; a builder 3026 for executing, for each digest retrieved at step (vii), the instructions to rebuild the corresponding program asset; and a flagging component 3028 for replacing the checked-in status of each digest retrieved with the checked-out status.

Referring now to FIG. 12, there is shown a sequence diagram of steps performed by the version control system 10 (see FIG. 6), for creating and deploying a package in Datastage™, i.e. an ETL library 38 (see FIG. 6), according to an embodiment of the present invention. The creation and deploying of a package is useful for example, in order to promote a group of versioned program assets from a development environment to a production environment.

Thus, a method 2400 for importing a package of versioned program assets into Datastage™ 38 from a database 18 is exemplified in FIG. 12. Each of said program asset is buildable in the Datastage™ 38 from a corresponding digest of instructions. One or more instance of the digest is stored in the database 18, each instance being associated to a version of the digest. The method 2400 comprises steps of:
a) receiving at 2422, via a user interface 12, a command for importing a new package;
b) receiving at 2438, via the user interface 12, the program assets to be imported via the new package and corresponding version information at 2430;
c) generating at 2428 the new package in the database 18, by means of an integration module 14;
d) retrieving at 2444 from the database 18, instances of the digests corresponding to the program assets to be imported, by means of the integration module 14, in accordance with the version information received at step (b) (2438);
e) associating at 2456 in the database 18, the instances retrieved at step (d) with the new package;
f) at 2456, by means of the integration module 14, setting a deployment status to the new package in the database 18; and
g) executing at 2458, the instructions of each of said instances associated to the new package, by means of the integration module, in order to import the corresponding program assets in Datastage™ 38.

In FIG. 12, steps 2412, 2414, 2416 and table 1852 relate to user authentication; steps 2418, 2420 and table 1812 relate to accessing a screen on the user interface 12 for accessing a release management user menu; steps 2422, 2424, 2426, 2428 and table 1826 relate to the creation of a package to be deployed in Datastage™; steps 2430, 2432, 2434, 2436, and table 1830 relate to a version branch selection; steps 2438, 2440, 2442, 2444, and table 1822 relate to versions of digests selected to include in the package; steps 2446 and 2448 relate to determining a target branch, namely the target environment in Datastage™ (development, production, test, etc.); steps 2450, 2452, 2454, 2458, 2456, 2460 and tables 1826, 1824 and 1828 relate to the deployment of the package in order to import the corresponding assets into Datastage™.

The one or more instance of the digest are grouped by branches in the database 18. Each branch corresponds to a subset of versions of the digest. Thus, the version information received at step (b) (2442) further includes branch information, and the retrieving of step (c) (2428) takes into account the branch information.

Thus, with reference to FIG. 14, the importation module 3020 further comprises a packaging module 3030 for generating a package and associating the package to import a plurality of the program assets received at the input port 3022, and for setting a deployed status to the package in the data storage to indicate that the package has updated the associated program assets in the library.

Referring now to FIG. 13, there is shown a sequence diagram of steps performed by the version control system, for comparing versions of a Datastage™ component, according to an embodiment of the present invention.

More particularly, a method 2600 for comparing versions of a given program asset in Datastage™ (i.e. ETL library) 38 is exemplified in FIG. 12. The given program asset is protected and buildable from a digest of instructions stored in a database 18, which stores multiple instances of the digest, each instance corresponding to a version of the given program asset (i.e. the database 18 stores several versions of a same program asset).

The method 2600 comprises steps of:
a) receiving at 2626 and 2634, via a user interface 12, instructions to compare two versions of said given program asset of Datastage™;
b) at 2628, retrieving from the database 18 two instances of the digest corresponding to said two versions of said given program asset, by means of an integration module 14;
c) at 2638, by means of an integration module 14, generating comparison information, by pairing matching components of the two instances; and
d) returning at 2634, by means of the integration module 14, the comparison information on the user interface 12.

In FIG. 13, steps 2612, 2614, 2216 and table 1852 relate to user authentication; steps 2618, 2620 and table 1812 relate to accessing a screen on the user interface 12 for prompting the comparison process; steps 2622, 2624, 2626, 2628 and table 1814 relate to the selection of versions of asset(s) to be compared; steps 2630, 2632, 2634, 2636, 2638, 2640 and table 1814 relate to the comparison of the program assets and the presenting of the resulting comparison information on the user interface 12.

Thus, with reference to FIG. 14, the integration module 14 further comprises a comparison module 3040 comprising: a comparison input port 3042 for receiving, a selection of the digest instances to be compared and corresponding version identifier; a retriever 3044 for retrieving the instances of the digest corresponding to the selection received; a comparer 3046 for comparing the content of the instances of the digest, to generate associated comparison information; and a comparison output port 3048 to send the comparison information for presentation on the user interface 12.

It is to be understood that one or more of a series of steps of the methods illustrated in FIGS. 10 to 13, may be performed within a same user session, i.e. without requiring a user long-on or even entering separate menu screens for each operation. Indeed, further to performing a check-in, for example, a user may immediately follow-up with a check-out operation, a package deployment operation and/or a comparison operation, or any combination thereof, without requiring to log-on between each operation, as may be easily understood by a person skilled in the art.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A method for managing versions of program assets of a library, each of said program assets having source code which is protected, the method being executable by a single utility application having an integration module which is embedded in a processor, the method comprising the steps of:
i) receiving a selection of one or more program asset to be exported into the utility application for storage;
ii) extracting from the library and into a digest, for each of the one or more program asset selected, instructions for building the source code of the corresponding program asset, by means of the integration module;
iii) storing, by means of the integration module, each digest as a new instance of the digest in a data storage;
iv) associating in the data storage, by means of the integration module, a new version identifier to each new instance of digest, the new version identifier representing a new version of the corresponding program asset; and
v) in the data storage, associating a checked-in status to each new instance of digest stored at step (iii), by means of the integration module, to indicate that each of said new instance of digest is stored in the utility application.

2. A method according to claim 1, wherein step (iv) comprises, for each digest:
querying the data storage to locate a prior instance of the digest; and
if said prior instance of the digest is located, determining a corresponding previous version identifier and setting said new version identifier associated to the digest, by incrementing the previous version identifier, or otherwise, setting said new version identifier to represent a first instance of the digest.

3. A method according to claim 2, wherein the incrementing of step (iv) is executed in accordance with one or more predefined incrementing rule.

4. A method according to claim 1, wherein the data storage stores instances of previously stored digests which are organized in a format of a tree having branches, each branch for a given one of the stored digests representing a subset of versions of the corresponding program asset, the method further comprising, prior to step (iv):
receiving a branch selection to which the new instance of the digest is to be associated with; and
retrieving branch information identifying the selected branch from the data storage; and
wherein the new version identifier of step (iv) is set based on said branch information.

5. A method according to claim 1, wherein each digest of step (ii) is provided in a file.

6. A method according to claim 1, wherein the one or more digest of step (ii) is provided in a same file.

7. A method according to claim 1, wherein the data storage comprises a plurality of said digests, each digest comprising instructions to rebuild a corresponding program asset in the library, the method further comprising:
vi) receiving, via a user interface, a selection of one or more of said program assets to be imported into the library and the corresponding version information;
vii) retrieving an instance of the digest from the data storage for each of said one or more program asset to be imported, by means of the integration module, being associated to the version information received at step (vi);
viii) for each digest retrieved at step (vii), executing the instructions to rebuild the corresponding program asset, by means of the integration module, in order to import a new version of the corresponding program asset into the library; and
ix) in the data storage, replacing a checked-in status associated each instance of the digest retrieved at step (vii) with a checked-out status, by means of the integration module, to indicate that the corresponding one or more program asset is currently being updated.

8. A method according to claim 1, wherein the data storage comprises a plurality of said digests, each digest comprising instructions to rebuild a corresponding program asset in the library, the method further comprising:
vi) receiving, via a user interface, a selection of one or more of said program assets to be imported into the library and the corresponding version information;
vii) retrieving an instance of the digest from the data storage for each of said one or more program asset to be imported, by means of the integration module, being associated to the version information received at step (vi); and
viii) validating whether said instance of digest retrieved at step (vii), has a checked-out status, and if the program asset does not have a checked-out status, proceeding to the steps of:
for each digest retrieved at step (vii), executing the instructions to rebuild the corresponding program asset, by means of the integration module, in order to import a new version of the corresponding program asset into the library; and
in the data storage, replacing a checked-in status associated each instance of the digest retrieved at step (vii) with a checked-out status, by means of the integration module, to indicate that the corresponding one or more program asset is currently being updated.

9. A method according to claim 7, wherein instances of digests are organized in the data storage, in a format of a tree having branches, each branch for a given digest representing a subset of versions of the corresponding program asset, wherein the version information received at step (vi) comprises branch information.

10. A method according to claim 7, wherein the selection received at step (vi) comprises a plurality of said program assets, the method further comprising:
generating a package to import the selection of program assets;
after step (vii), associating in the data storage, the instances retrieved at step (vii) with the package; and
after step (viii), setting a deployed status to the new package in the data storage to indicate that the package has updated the associated program assets in the library.

11. A method according to claim 1, wherein the data storage comprises a plurality of said digests, each digest comprising instructions to rebuild a corresponding program asset in the library, the data storage storing multiple instances of at least one of the digests, each instance corresponding to a version of the corresponding program asset, the method further comprising:
receiving a selection of two or more digest instances of the data storage and corresponding version identifier, to be compared;
retrieving from the data storage the instances of the digest corresponding to the selection received;
by means of the integration module, comparing the content of the digest instance, to generate comparison information; and
returning the comparison information on a user interface component.

12. A method according to claim 11, wherein said comparison information is returned as at least one of:
text comparison of each digest instance to be compared; and
comparison of program features of the program asset associated to each digest instance to be compared.

13. A system for managing versions of program assets of a library, each of said program assets having source code which is protected, the system comprising:
a user interface for receiving a selection of one or more program asset to be exported into a utility application for editing;
an integration module embedded in a processor which is in communication with the user interface, the integration module comprising an exportation module for extracting from the library into a digest, for each of the one or more program asset selected, instructions for building the source code of the corresponding program asset; and
a data storage, in communication with the integration module, for storing each digest as a new instance of the digest, and for associating a new version identifier to each new instance of digest, the new version identifier representing a new version of the corresponding program asset, and for further associating a checked-in status to each new instance of digest stored to indicate that each of said new instance of digest is stored in the utility application.

14. A system according to claim 13, wherein the data storage comprises a plurality of said digests, each digest comprising instructions to rebuild a corresponding program asset in the library, wherein the integration module further comprises an importation module comprising:
an importation input port for receiving, from the user interface, a selection of one or more of said program assets to be imported into the library and the corresponding version information;
a collector for retrieving an instance of the digest from the data storage for each of said one or more program asset to be imported, being associated to the version information received by the user interface;
a builder for executing, for each digest retrieved, the instructions to rebuild the corresponding program asset, by means of the integration module, in order to import a new version of the corresponding program asset into the library; and
a flagging component for replacing a checked-in status associated with each instance of the digest retrieved in the data storage with a checked-out status, in order to indicate that the corresponding one or more program asset is currently being updated.

15. A system according to claim 14, wherein the importation module further comprises:
a packaging module for generating a package and associating said package to import a plurality of the program assets received at the input port, and for setting a deployed status to the package in the data storage to indicate that the package has updated the associated program assets in the library.

16. A system according to claim 13, wherein the integration module further comprises a comparison module comprising:
a comparison input port for receiving, from the user interface, a selection of two or more digest instances of the data storage and corresponding version identifier, to be compared;
an retriever for retrieving from the data storage, the instances of the digest corresponding to the selection received;
a comparer for comparing the content of the instances of the digest, to generate associated comparison information; and
a comparison output port to send the comparison information for presentation on the user interface.

17. A storage medium for managing versions of program assets of a library, each of said program assets having source code which is protected, the storage medium being processor-readable and non-transitory, the storage medium comprising instructions for execution by a processor, via a single utility application, to:
i) receive a selection of one or more program asset to be exported into the utility application for storage;
ii) extract from the library and into a digest, for each of the one or more program asset selected, instructions for building the source code of the corresponding program asset, by means of the integration module;
iii) store, by means of the integration module, each digest as a new instance of the digest in a data storage;
iv) associate in the data storage, by means of the integration module, a new version identifier to each new instance of digest, the new version identifier representing a new version of the corresponding program asset; and
v) associated, in the data storage, a checked-in status to each new instance of digest stored at (iii), by means of the integration module, to indicate that each of said new instance of digest is stored in the utility application.

18. A storage medium according to claim 17, wherein the instructions to associate at (iv) comprise instructions to:
query the data storage to locate a prior instance of the digest; and
if said prior instance of the digest is located, determine a corresponding previous version identifier and set said new version identifier associated to the digest, by incrementing the previous version identifier, or otherwise, set said new version identifier to represent a first instance of the digest.

19. A storage medium according to claim 18, wherein the instructions to increment are executable in accordance with one or more predefined incrementing rule.

20. A storage medium according to claim 17, wherein the data storage stores instances of previously stored digests which are organized in a format of a tree having branches, each branch for a given one of the stored digests representing a subset of versions of the corresponding program asset, the storage medium further comprising instructions to, prior to the associating at (iv):
receive a branch selection to which the new instance of the digest is to be associated with; and
retrieve branch information identifying the selected branch from the data storage; and
wherein the new version identifier of step (iv) is set based on said branch information.

21. A storage medium according to claim 17, wherein the instructions to extract at (ii) comprise instructions to generate each digest in a file.

22. A storage medium according to claim 17, wherein the instructions to extract at (ii) comprise instructions to generate one or more of said digest in a same file.
